(19) United States
(12) Patent Application Publication
(10) Pub. No.: US 2005/0174304 A1
(43) Pub. Date: Aug. 11, 2005

(54) Method of driving display panel

(76) Inventors: Joon-Koo Kim, Asan-si (KR); Nam-Sung Jung, Yongin-si (KR)

Correspondence Address: Robert E. Bushnell, Suite 300, 1522 K Street, N.W., Washington, DC, 20005, US

(21) Appl. No.: 11/029,385

(22) Filed: Jan. 6, 2005

(30) Foreign Application Priority Data
Feb. 9, 2004 (KR) 2004-8252

(51) Int. Cl. G09G 3/28

(52) U.S. Cl. 345/60

(57) ABSTRACT

A method of driving a display panel includes: quantizing a sustain pulse; and performing a sustain discharge by supplying a ramp-type sustain pulse in at least one sub-field. Accordingly, it is possible to prevent low gray-scale display deterioration due to the quantization of sustain pulses by performing a sustain discharge using a ramp-type sustain pulse.

### CLAIM OF PRIORITY

This application makes reference to, incorporates the same herein, and claims all benefits accruing under 35 U.S.C. §119 from an application for PANEL DRIVING METHOD earlier filed in the Korean Intellectual Property Office on 9 Feb. 2004 and there duly assigned Serial No. 2004-8252.

### BACKGROUND OF THE INVENTION

1. Field of the Invention

The present invention relates to a method of driving a display panel which displays an image by supplying sustain pulses to an electrode structure defining display cells, such as a Plasma Display Panel (PDP). The present invention also relates to a program storage device, readable by a machine, tangibly embodying a program instructions executable by the machine to perform the method of driving a display panel.

2. Description of the Related Art

In a PDP with a 3-electrode surface discharge structure, address electrode lines A₁, A₂, . . . , A_{Bm}, dielectric layers, Y electrode lines Y₁, . . . , Yₙ, X electrode lines X₁, . . . , Xₙ, phosphors, partition walls, and an MgO layer functioning as a protection layer, are formed between front and rear glass substrates of the PDP panel.

The address electrode lines A₁, A₂, . . . , Aₘ are formed in a predetermined pattern on an upper surface of the rear glass substrate. The lower dielectric layer covers the address electrode lines A₁, A₂, . . . , Aₘ. The partition walls are formed on the surface of the lower dielectric layer parallel to the address electrode lines A₁, A₂, . . . , Aₘ. The partition walls partition discharge areas of display cells and prevents cross-talk between the display cells. The phosphors are formed between each pair of adjacent partition walls.

The X electrode lines X₁, . . . , Xₙ and Y electrode lines Y₁, . . . , Yₙ constituting display electrode line pairs are formed in a predetermined pattern on a lower surface of the front glass substrate in such a way as to intersect the address electrode lines A₁, A₂, . . . , Aₘ. Each of the intersections forms a corresponding display cell. Each of the X-electrode lines X₁, . . . , Xₙ and each of the Y-electrode lines Y₁, . . . , Yₙ are formed by coupling transparent electrode lines composed of a transparent conductive material such as ITO (Indium Tin Oxide) with metal electrode lines for enhancing conductivity. The upper dielectric layer covers the X-electrode lines X₁, . . . , Xₙ and Y electrode lines Y₁, . . . , Yₙ. A protection layer protecting the panel from a strong electric field, for example, a MgO layer, is formed on the rear surface of the upper dielectric layer. A discharge space is filled with a plasma-forming gas and is sealed.

A method of driving a PDP as described above sequentially performs an initializing step, an addressing step, and a display sustain step in a unit sub-field. In the initializing step, electrical charges in all of the display cells are uniformly distributed. In the addressing step, the state of electrical charges in display cells to be selected and the state of electrical charges in display cells not to be selected are set. In the display sustain step, a display discharge is generated in the display cells to be selected. A plasma is generated by the plasma-forming gas in the display cells causing the display discharge and the phosphors of the display cells are excited by ultraviolet radiation of the plasma, thereby generating light.

The driving apparatus for driving the PDP includes an image processor, a controller, an address driver, a X driver, and a Y driver. The image processor converts external analog image signals into digital signals to generate internal image signals, for example, red (R), green (G), and blue (B) image data each having 8 bits, clock signals, and vertical and horizontal synchronization signals. The controller generates driving control signals S_{A}, S_{Y}, and S_{X} according to the internal image signals output from the image processor. The address driver processes an address signal S_{A} among the driving control signals S_{A}, S_{Y}, and S_{X} output from the controller 202, generates a display data signal, and supplies the display data signal to the address electrode lines. The X driver processes a X driving control signal S_{X} among the driving control signals S_{A}, S_{Y}, and S_{X} output from the controller and supplies the X driving control signal S_{X} to the X electrode lines. The Y driver processes a Y driving control signal S_{Y} among the driving control signals S_{A}, S_{Y}, and S_{X} output from the controller and supplies the Y driving control signal S_{Y} to the Y electrode lines.

U.S. Pat. No. 5,541,618, entitled: Method and a Circuit For Gradually Driving a Flat Display Device, relates to one method of driving the PDP as described above.

In an address-display separation driving method applied to the Y electrode lines of the PDP described above, each of unit frames is partitioned into 8 sub-fields SF1, . . . , SF8 in order to implement time-division gradation display. The sub-fields SF1, . . . , SF8 are respectively divided into resetting times (not shown), addressing times A1, . . . , A8, and discharge sustain periods S1, . . . , S8.

In each of the addressing times A1, . . . , A8, a display data signal is supplied sequentially to the address electrode lines A₁, A₂, . . . , Aₘ while injection pulses corresponding to each of the Y electrode lines Y₁, . . . , Yₙ are supplied sequentially to the address electrode lines A₁, A₂, . . . , Aₘ.

In each of the display sustain times S1, . . . , S8, display sustain pulses are supplied alternately to all of the Y electrode lines Y₁, . . . , Yₙ and all of the X electrode lines X₁, . . . , Xₙ, so that the discharge cells in which the wall charges are formed cause a display discharge in the corresponding addressing times A1, . . . , A8.

The brightness of the PDP is proportional to the number of sustain discharge pulses in sustain discharge times S1, . . . , S8 occupied by a unit frame. If a frame forming an image is represented by 8 sub-fields and 256 gradations, the different numbers (1, 2, 4, 8, 16, 32, 64, and 128) of sustain pulses can be sequentially allocated to the respective sub-fields. Accordingly, to achieve the brightness of 133 gradations, it is necessary to address and sustain-discharge cells during the times of sub-fields SF1, SF3, and SF8.

The numbers of sustain-discharge pulses allocated to the respective sub-fields can be changeably set according to the weights of sub-fields on the basis of Automatic Power Control (APC). Also, the numbers of sustain-discharge pulses allocated to the respective sub-fields can be changed according to gamma characteristics or panel characteristics. For example, it is possible to decrease a gradation allocated to a sub-field SF4 from 8 to 6 and to increase a gradation allocated to a sub-field SF6 from 32 to 34. Also, the number of sub-fields forming a frame can be changed according to a design rule.

The driving signal for driving the PDP described above is a driving signal supplied to address electrodes A, common electrodes X, and scanning electrodes Y₁, . . . , Yₙ in a sub-field SF according to the ADS driving method for an AC PDP. A sub-field SF includes a reset period PR, an addressing period PA, and a sustain-discharge period PS.

During the reset period PR, reset pulses are supplied to all scanning electrode line groups, so that a write discharge is performed and wall electrical charges are uniformly distributed in all of the display cells. Since the reset period PR is performed over an entire screen before the addressing period PA, wall electrical charges can be distributed uniformly. Accordingly, the states of the wall electrical charges of the display cells initialized during the reset period PR are uniform. After the reset period PR, the addressing period PA is performed. During the addressing period PA, a bias voltage Ve is supplied to the common electrodes X, and scanning electrodes Y₁, . . . , Yₙ and address electrodes A₁, A₂, . . . , Aₘ at the location of a cell to be displayed are simultaneously turned on, thereby selecting a display cell. After the addressing period PA, a sustain pulse Vs is alternately supplied to the common electrodes X and the scanning electrodes Y₁, . . . , Yₙ, so that the sustain-discharge period PS is performed. During the sustain-discharge period PS, a voltage VG with a low level is supplied to the address electrodes A₁, . . . , Aₘ.

The brightness of a PDP is controlled by the number of sustain-discharge pulses. As the number of sustain-discharge pulses in one sub-field or one TV field increases, the brightness increases.

If the number (N max ) of sustain-discharge pulses is provided in one frame, the number (Ni) of sustain-discharge pulses allocated to an i-th sub-field can be calculated by equation 1.

$$Ni = round ( {Ni}_{real} ) = round ( N max \frac{{W}_{i}}{\sum {W}_{i}} ) \qquad ( 1 )$$

Wᵢ is a weight of the i-th sub-field and ΣWᵢ is the total weights of sub-fields consisting of a TV field. Since Ni must be an integer, Niᵣₑₐₗ must be rounded off. The rounding-off corresponds to quantization or integerization of the number of the sustain-discharge pulses.

The number of sustain pulses is determined by such a quantization and the amount of radiation of the sub-fields is determined according to the number of sustain pulses.

In the PDP, an amount of radiation generated by a sustain pulse is changed according to the radiation efficiency of a panel design rule, the waveform of a driving signal, and a driving voltage. Generally, it is known that an amount of radiation generated by a sustain discharge is between 0.3 to 0.8 cd/m².

If an amount of radiation generated by a sustain discharge is 0.5 cd/m² and N max=1000, the brightness of 2N max×0.5 cd / m² is obtained. In this case, a minimum sustain-discharge amount of radiation of the PDP is 1 cd/m². To obtain a gradation lower than the brightness, a dithering technique, etc. must be used.

Also, if N max is small, a situation occurs where a gray scale ratio allocated to all of the sub-fields is not received due to sustain pulses allocated to low gray-scale sub-fields during a quantization step. In other words, this deteriorates a low gray-scale.

### SUMMARY OF THE INVENTION

The present invention provides a method of driving a display panel for enhancing a low gray-scale resolution.

According to one aspect of the present invention, a method of driving a display panel is provided, the method comprising: quantizing a sustain pulse; and performing a sustain discharge by supplying a ramp-type sustain pulse in at least one sub-field.

Performing a sustain discharge preferably comprises supplying the ramp-type sustain pulse in a sustain period of at least one sub-field upon the sustain period in which an integer portion obtained via quantization of the sustain pulse is equal to zero.

Performing a sustain discharge preferably comprises supplying the ramp-type sustain pulse in at least one sub-field in accordance with a sum of quantization errors of a sub-field in which an integer portion obtained via quantization of a sustain pulse is equal to zero.

The method further preferably comprises changing a ramp-wave maximum voltage of the ramp-type sustain pulse.

The method further preferably comprises changing a ramp-wave rising period of the ramp-type sustain pulse.

According to another aspect of the present invention, a method of driving a display panel is provided, the method comprising: quantizing the number of sustain pulses of a sustain discharge supplied to a sub-field; supplying a quantized integer portion of each sustain pulse of a sustain discharge as a square wave sustain pulse; and supplying a quantization error portion of each sustain pulse of a sustain discharge as a ramp-type sustain pulse.

The method further preferably comprises changing a ramp-wave maximum voltage of the ramp-type sustain pulse.

The method further preferably comprises changing a ramp-wave rising period of the ramp-type sustain pulse.

According to yet another aspect of the present invention, a program storage device, readable by a machine, tangibly embodying a program instructions executable by the machine to perform a method of driving a display panel is provided, the method comprising: quantizing a sustain pulse; and performing a sustain discharge by supplying a ramp-type sustain pulse in at least one sub-field.

Performing a sustain discharge preferably comprises supplying the ramp-type sustain pulse in a sustain period of at least one sub-field upon the sustain period in which an integer portion obtained via quantization of the sustain pulse is equal to zero.

Performing a sustain discharge preferably comprises supplying the ramp-type sustain pulse in at least one sub-field in accordance with a sum of quantization errors of a sub-field in which an integer portion obtained via quantization of a sustain pulse is equal to zero.

The method further preferably comprises changing a ramp-wave maximum voltage of the ramp-type sustain pulse.

The method further preferably comprises changing a ramp-wave rising period of the ramp-type sustain pulse.

According to still another aspect of the present invention, a program storage device, readable by a machine, tangibly embodying a program instructions executable by the machine to perform a method of driving a display panel is provided, the method comprising: quantizing the number of sustain pulses of a sustain discharge supplied to a sub-field; supplying a quantized integer portion of each sustain pulse of a sustain discharge as a square wave sustain pulse; and supplying a quantization error portion of each sustain pulse of a sustain discharge as a ramp-type sustain pulse.

The method further preferably comprises changing a ramp-wave maximum voltage of the ramp-type sustain pulse.

The method further preferably comprises changing a ramp-wave rising period of the ramp-type sustain pulse.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of a PDP with a 3-electrode surface discharge structure;

FIG. 2 is a block diagram of a driving apparatus of the PDP of FIG. 1;

FIG. 3 is a timing diagram for explaining an Address-Display Separation driving method applied to Y electrode lines of the PDP of FIG. 1;

FIG. 4 is a timing diagram for explaining an exemplary driving signal for driving the PDP of FIG. 1;

FIG. 5 is a waveform for explaining a relationship between the amount of radiation and sustain pulses supplied to scanning electrodes Y and common electrodes X;

FIG. 6 is a characteristic graph of power control according to an average signal level in a PDP;

FIG. 7A is a waveform for explaining a relationship between a waveform of a square wave sustain pulse and an amount of radiation;

FIG. 7B is a waveform for explaining a relationship between a waveform of a ramp-type sustain pulse according to an embodiment of the present invention and an amount of radiation;

FIGS. 8A through 8C are waveforms for explaining ramp-type sustain pulses according to an embodiment of the present invention;

FIG. 9 is a graph of a proportional relationship between a ramp-wave rising time tr shown in FIGS. 8A through 8C and a radiation strength; and

FIG. 10 is a waveform of an exemplary sub-field of the ramp-type sustain pulse according to an embodiment of the present invention.

### DETAILED DESCRIPTION OF THE INVENTION

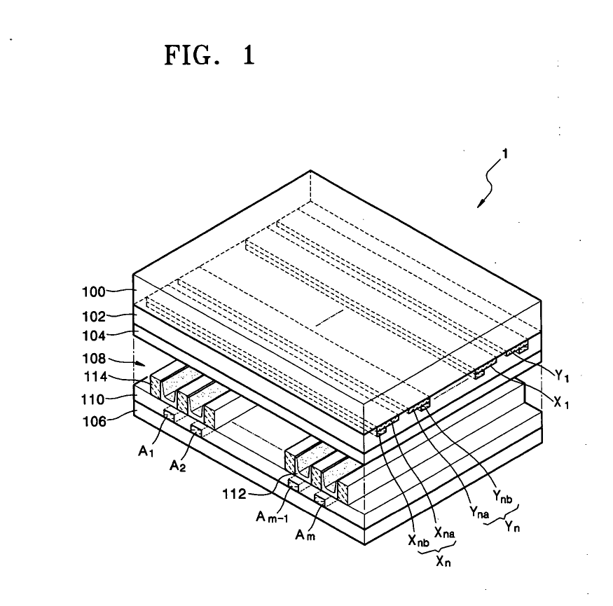

FIG. 1 is a perspective view of a PDP with a 3-electrode surface discharge structure.

Referring to FIG. 1, address electrode lines A₁, A₂, . . . , A_{Bm}, dielectric layers 102 and 110, Y electrode lines Y₁, . . . , Yₙ, X electrode lines X₁, . . . , Xₙ, phosphors 112, partition walls 114, and an MgO layer 104 functioning as a protection layer, are formed between front and rear glass substrates 100 and 106 of the PDP panel 1.

The address electrode lines A₁, A₂, . . . , Aₘ are formed in a predetermined pattern on an upper surface of the rear glass substrate 106. The lower dielectric layer 110 covers the address electrode lines A₁, A₂, . . . , Aₘ. The partition walls 114 are formed on the surface of the lower dielectric layer 110 parallel to the address electrode lines A₁, A₂, . . . , Aₘ. The partition walls 114 partition discharge areas of display cells and prevents cross-talk between the display cells. The phosphors 112 are formed between each pair of adjacent partition walls 114.

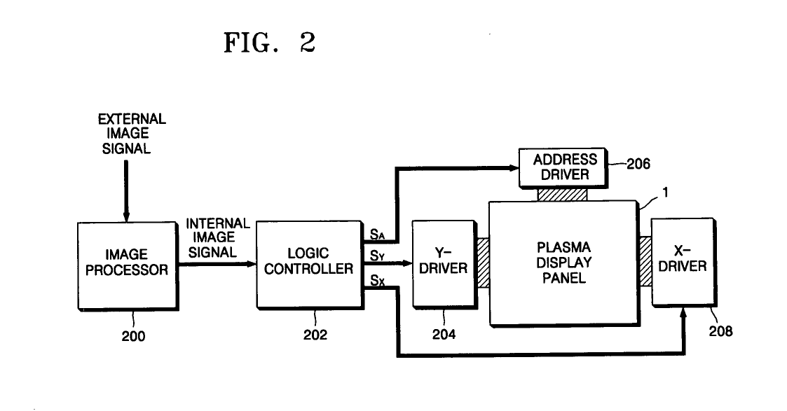

The X electrode lines X₁, . . . , Xₙ and Y electrode lines Y₁, . . . , Yₙ constituting display electrode line pairs are formed in a predetermined pattern on a lower surface of the front glass substrate 100 in such a way as to intersect the address electrode lines A₁, A₂, . . . , Aₘ. Each of the intersections forms a corresponding display cell. Each of the X-electrode lines X₁, . . . , Xₙ and each of the Y-electrode lines Y₁, . . . , Yₙ are formed by coupling transparent electrode lines (Xₙₐ and Yₙₐ and of FIG. 2) composed of a transparent conductive material such as ITO (Indium Tin Oxide) with metal electrode lines (X_{nb} and Y_{nb}) for enhancing conductivity. The upper dielectric layer 102 covers the X-electrode lines X₁, . . . , Xₙ and Y electrode lines Y₁, . . . , Yₙ. A protection layer 104 protecting the panel I from a strong electric field, for example, a MgO layer, is formed on the rear surface of the upper dielectric layer 102. A discharge space 108 is filled with a plasma-forming gas and is sealed.

A method of driving a PDP as described above sequentially performs an initializing step, an addressing step, and a display sustain step in a unit sub-field. In the initializing step, electrical charges in all of the display cells are uniformly distributed. In the addressing step, the state of electrical charges in display cells to be selected and the state of electrical charges in display cells not to be selected are set. In the display sustain step, a display discharge is generated in the display cells to be selected. A plasma is generated by the plasma-forming gas in the display cells causing the display discharge and the phosphors 112 of the display cells are excited by ultraviolet radiation of the plasma, thereby generating light.

FIG. 2 is a block diagram of a driving apparatus of the PDP of FIG. 1.

Referring to FIG. 2, the driving apparatus for driving the PDP 1 includes an image processor 200, a controller 202, an address driver 206, a X driver 208, and a Y driver 204. The image processor 200 converts external analog image signals into digital signals to generate internal image signals, for example, red (R), green (G), and blue (B) image data each having 8 bits, clock signals, and vertical and horizontal synchronization signals. The controller 202 generates driving control signals S_{A}, S_{Y}, and S_{X} according to the internal image signals output from the image processor 200. The address driver 206 processes an address signal S_{A} among the driving control signals S_{A}, S_{Y}, and S_{X} output from the controller 202, generates a display data signal, and supplies the display data signal to the address electrode lines. The X driver 208 processes a X driving control signal S_{X} among the driving control signals S_{A}, S_{Y}, and S_{X} output from the controller 202 and supplies the X driving control signal S_{X} to the X electrode lines. The Y driver 204 processes a Y driving control signal S_{Y} among the driving control signals S_{A}, S_{Y}, and S_{X} output from the controller 202 and supplies the Y driving control signal S_{Y} to the Y electrode lines.

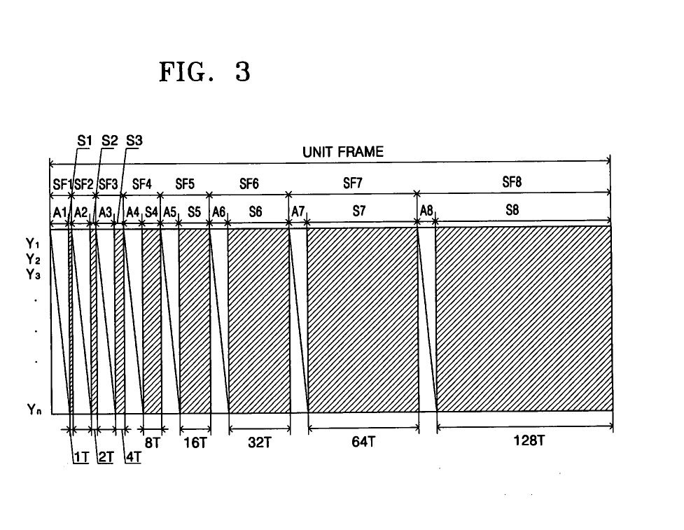

FIG. 3 is a timing diagram for explaining an Address-Display Separation driving method applied to the Y electrode lines of the PDP of FIG. 1.

Referring to FIG. 3, each of unit frames is partitioned into 8 sub-fields SF1, . . . , SF8 in order to implement time-division gradation display. The sub-fields SF1, . . . , SF8 are respectively divided into resetting times (not shown), addressing times A1, . . . , A8, and discharge sustain periods S1, . . . , S8.

In each of the addressing times A1, . . . , A8, a display data signal is supplied sequentially to the address electrode lines (A₁, A₂, . . . , Aₘ of FIG. 1) while injection pulses corresponding to each of the Y electrode lines Y₁, . . . , Yₙ are supplied sequentially to the address electrode lines A₁, A₂, . . . , Aₘ.

In each of the display sustain times S1, . . . , S8, display sustain pulses are supplied alternately to all of the Y electrode lines Y₁, . . . , Yₙ and all of the X electrode lines X₁, . . . , Xₙ, so that the discharge cells in which the wall charges are formed cause a display discharge in the corresponding addressing times A1, . . . , A8.

The brightness of the PDP is proportional to the number of sustain discharge pulses in sustain discharge times S1, . . . , S8 occupied by a unit frame. If a frame forming an image is represented by 8 sub-fields and 256 gradations, the different numbers (1, 2, 4, 8, 16, 32, 64, and 128) of sustain pulses can be sequentially allocated to the respective sub-fields. Accordingly, to achieve the brightness of 133 gradations, it is necessary to address and sustain-discharge cells during the times of sub-fields SF1, SF3, and SF8.

The numbers of sustain-discharge pulses allocated to the respective sub-fields can be changeably set according to the weights of sub-fields on the basis of Automatic Power Control (APC). Also, the numbers of sustain-discharge pulses allocated to the respective sub-fields can be changed according to gamma characteristics or panel characteristics. For example, it is possible to decrease a gradation allocated to a sub-field SF4 from 8 to 6 and to increase a gradation allocated to a sub-field SF6 from 32 to 34. Also, the number of sub-fields forming a frame can be changed according to a design rule.

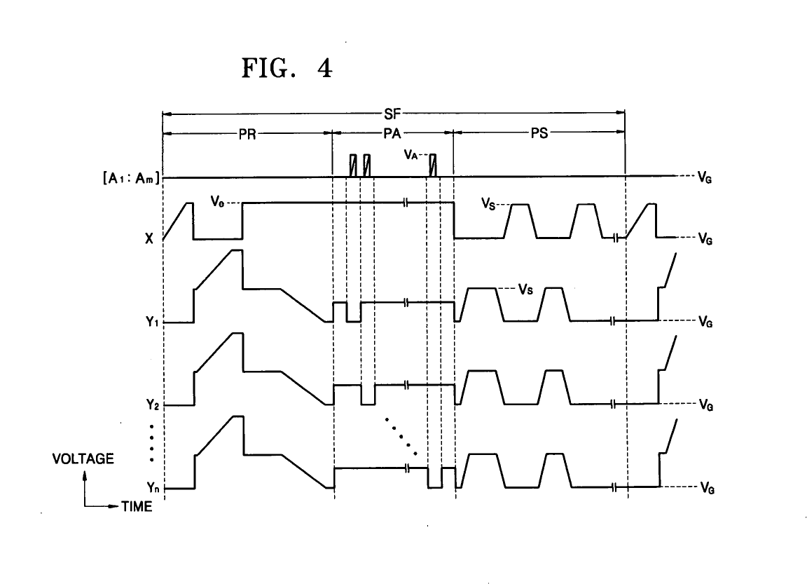

FIG. 4 is a timing diagram for explaining an exemplary driving signal for driving the PDP of FIG. 1, wherein the driving signal is a driving signal supplied to address electrodes A, common electrodes X, and scanning electrodes Y₁, . . . , Yₙ in a sub-field SF according to the ADS driving method for an AC PDP. Referring to FIG. 4, a sub-field SF includes a reset period PR, an addressing period PA, and a sustain-discharge period PS.

During the reset period PR, reset pulses are supplied to all scanning electrode line groups, so that a write discharge is performed and wall electrical charges are uniformly distributed in all of the display cells. Since the reset period PR is performed over an entire screen before the addressing period PA, wall electrical charges can be distributed uniformly. Accordingly, the states of the wall electrical charges of the display cells initialized during the reset period PR are uniform. After the reset period PR, the addressing period PA is performed. During the addressing period PA, a bias voltage Ve is supplied to the common electrodes X, and scanning electrodes Y₁, . . . , Yₙ and address electrodes A₁, A₂, . . . , Aₘ at the location of a cell to be displayed are simultaneously turned on, thereby selecting a display cell. After the addressing period PA, a sustain pulse Vs is alternately supplied to the common electrodes X and the scanning electrodes Y₁, . . . , Yₙ, so that the sustain-discharge period PS is performed. During the sustain-discharge period PS, a voltage VG with a low level is supplied to the address electrodes A₁, . . . , Aₘ.

The brightness of a PDP is controlled by the number of sustain-discharge pulses. As the number of sustain-discharge pulses in one sub-field or one TV field increases, the brightness increases.

If the number (N max ) of sustain-discharge pulses is provided in one frame, the number (Ni) of sustain-discharge pulses allocated to an i-th sub-field can be calculated by equation 1.

$$Ni = round ( {Ni}_{real} ) = round ( N max \frac{{W}_{i}}{\sum {W}_{i}} ) \qquad ( 1 )$$

Wᵢ is a weight of the i-th sub-field and ΣWᵢ is the total weights of sub-fields consisting of a TV field. Since Ni must be an integer, Niᵣₑₐₗ must be rounded off. The rounding-off corresponds to quantization or integerization of the number of the sustain-discharge pulses.

The number of sustain pulses is determined by such quantization and the amount of radiation of the sub-fields is determined according to the number of sustain pulses.

In the PDP, an amount of radiation generated by a sustain pulse is changed according to the radiation efficiency of a panel design rule, the waveform of a driving signal, and a driving voltage. Generally, it is known that an amount of radiation generated by a sustain discharge is between 0.3 to 0.8 cd/m².

If an amount of radiation generated by a sustain discharge is 0.5 cd/m² and N max=1000, the brightness of 2N maxx0.5 cd / m² is obtained. In this case, a minimum sustain-discharge amount of radiation of the PDP is 1 cd/m². To obtain a gradation lower than the brightness, a dithering technique, etc. must be used.

Also, if N max is small, a situation occurs where a gray scale ratio allocated to all of the sub-fields is not received due to sustain pulses allocated to low gray-scale sub-fields during a quantization step. In other words, this deteriorates a low gray-scale.

Hereinafter, embodiments of the present invention will be described in detail with reference to the appended drawings.

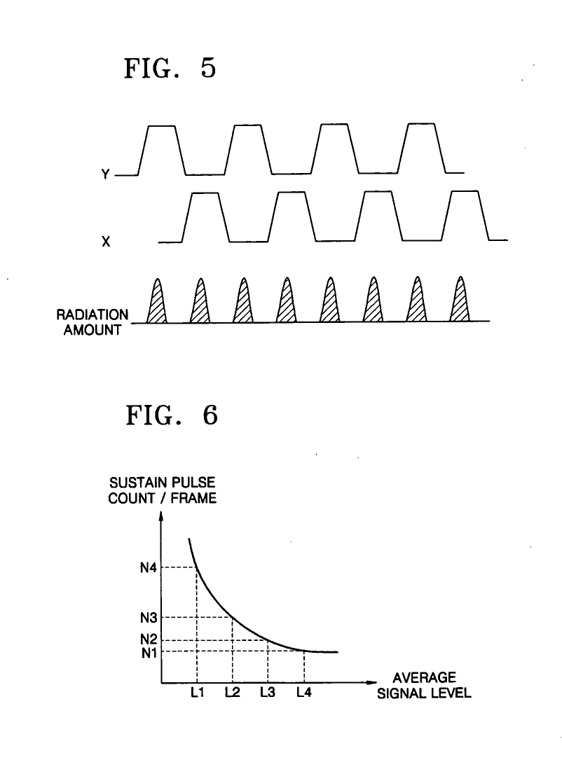

FIG. 5 is a waveform for explaining a relationship between the amount of radiation and sustain pulses supplied to scanning electrodes Y and common electrodes X.

Since a sustain pulse supplied to a sub-field is supplied as a pair of XY sustain pulses such that one sustain pulse is supplied to a scan electrode and the other sustain pulse is supplied to a common electrode, N pairs of sustain pulses generate sustain discharges 2N times. Accordingly, for example, if a brightness of 0.5 cd/m² is obtained by a sustain discharge, a minimum brightness resolution for a sustain discharge becomes 2×0.5=1 cd/m². This means that the rate of the brightness increase cannot be smaller than 1 cd/m² at a low gradation. To remove such a limitation in the brightness resolution of the PDP, an error expansion technique or a dithering technique are used to enhance the brightness resolution of the PDP. However, the dithering technique deteriorates a spatial resolution of an original image, which causes picture-quality deterioration and dithering noises.

A PDP controls its power consumption using an Average Signal Level (ASL). For example, the PDP maintains its power consumption below a predetermined level by changing N max (the total number of sustain pulses) of equation 1. That is, the PDP uses a function of Nmax=Nmax(ASL).

FIG. 6 is a characteristic graph of power control according to an average signal level in a PDP. FIG. 6 is a view of a power control process consisting of four steps. However, the power control process can be implemented by an LUT (Look-up Table) including more steps as necessary.

Referring to FIG. 6, a highest sustain discharge count N4 is used for from 0 to L1 corresponding to a lowest average signal level. A sustain discharge count N3 is used for an average signal level which is higher than L1 and lower than L2. A sustain discharge count N2 is used for an average signal level which is higher than L2 and lower than L3. A lowest sustain discharge count N1 is used for an average signal level which is higher than L3.

An exemplary LUT is given as Table 1, as follows.

TABLE 1

| | Sub-field | | | | | | | |
|---|---|---|---|---|---|---|---|---|
| | 1 | 2 | 3 | 4 | 5 | 6 | 7 | 8 |
| weight | 1 | 2 | 4 | 8 | 16 | 32 | 64 | 128 |
| N4 = 255 | 1 | 2 | 4 | 8 | 16 | 32 | 64 | 128 |
| N3 = 128 | 1 | 1 | 2 | 4 | 8 | 16 | 32 | 64 |
| N2 = 64 | 0 | 1 | 1 | 2 | 4 | 8 | 16 | 32 |
| N1 = 32 | 0 | 0 | 1 | 1 | 2 | 4 | 8 | 16 |

For example, when an average signal level is very high, such as a white pattern, N max<<ΣWi, and accordingly a case where a sustain-pulse corresponding to a sub-field with a low weight becomes smaller than 1, occurs. This causes low gray-scale display deterioration.

This is due to non-linearity of a sustain discharge, that is, because an amount of radiation generated by a sustain discharge is defined only by an integer multiple of the number of sustain pulses. This is because square wave sustain pulses are used.

In more detail, referring to Table 1, in the case of N max=64, no sustain pulse is allocated to the first sub-field. Also, in the case of Nmax=32, no sustain pulse is allocated to the first sub-field and the second sub-field.

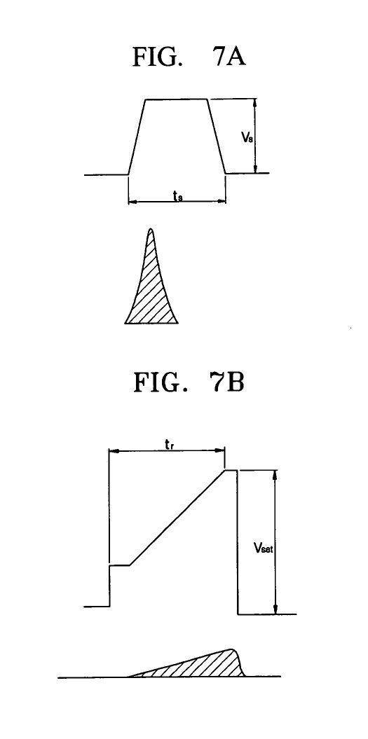

FIG. 7A is a waveform for explaining a relationship between a waveform of a square wave sustain pulse and an amount of radiation.

In general, a sustain-pulse generates a sustain voltage change during a very short time period. That is, since sustain discharges are generated by sustain pulses having a similar form with a square wave, a linear change of the amount of radiation corresponding to the sustain discharges cannot be induced. Accordingly, due to the square-wave sustain pulses, only gradations that are proportional to the number of sustain pulses allocated to respective sub-fields are obtained.

In particular, if the average signal level is very high, a sustain pulse allocated to a low gray-scale sub-field can become smaller than 1 in the quantization step using equation 1. In this case, the corresponding sub-field can be disabled by the square wave sustain pulse of FIG. 7A.

To display a portion having such a quantization error, the present invention proposes a sustain pulse which generates radiation linearly with respect to its pulse width.

FIG. 7B is a waveform for explaining a relationship between a waveform of a ramp-type sustain pulse and the amount of radiation. The ramp-type sustain pulse of FIG. 7B generates a weak discharge. It is seen in FIG. 7B that the amount of radiation increases as a ramp-wave maximum voltage Vset is higher or as a ramp-wave rising time Tr is longer. Therefore, it is possible to display a gradation of the portion having the quantization error shown in FIG. 4 on a panel, using the ramp-type sustain pulse shown in FIG. 7B.

Equations 2 through 4 below are quantization equations of sustain pulses for performing a sustain discharge using ramp-type sustain pulses.

$$\begin{matrix}Ni = N max \cdot \frac{Wi}{\sum Wi} & ( 2 ) \\ Ni = [ Ni ] + α & ( 3 ) \\ α + Ni - [ Ni ] & ( 4 )\end{matrix}$$

[Ni] is a quantized integer portion of Ni, for example, [Ni]=3 if Ni=3.4. In this case, a quantization error a is 0.4 and a portion having the quantization error cannot be displayed by the square wave sustain discharge pulse of FIG. 7A.

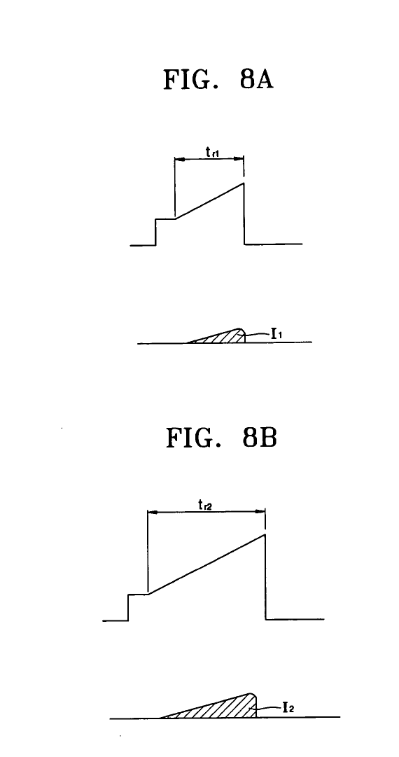

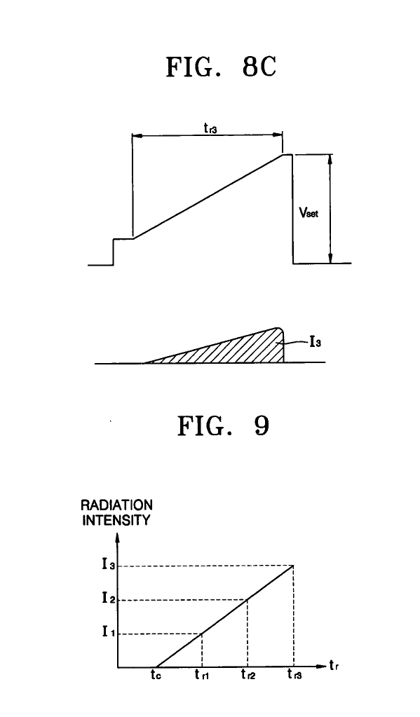

A method of displaying the quantization error α (0<α<1) is described below with reference to FIGS. 8A through 8C.

FIGS. 8A through 8C are waveforms for explaining ramp-type sustain pulses according to an embodiment of the present invention. Referring to FIGS. 8A through 8C, as a rising time of a ramp-wave increases in an order to tr1→tr2→tr3 when the gradient of the ramp-wave is constant, a corresponding radiation strength increases in an order of I1→I2→I3. While not shown in the drawings, the radiation strength can also be controlled by adjusting a ramp-wave maximum voltage Vset by fixing the ramp-wave rising time.

FIG. 9 is a graph of a proportional relationship between the pulse rising time tr of FIG. 8A and the radiation intensity. Referring to FIG. 9, as a rising time of a ramp-wave increases in an order of tr1→tr2→tr3 when the gradient of the ramp-wave is constant after a cut-off time tc, a corresponding radiation strength increases in an order of I1→I2→I3

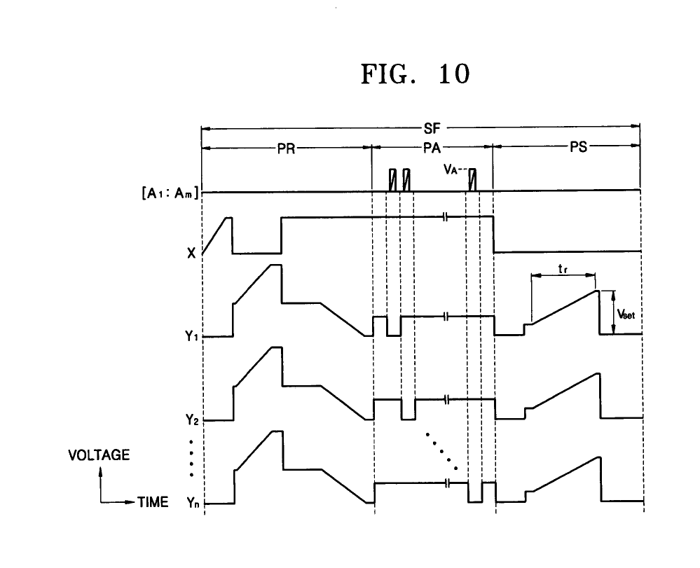

FIG. 10 is a waveform of an exemplary sub-field of the ramp-type sustain pulse according to an embodiment of the present invention. A ramp-type sustain pulse of FIG. 10 is supplied to at least one sub-field among sub-fields consisting of a TV frame, thereby performing a sustain discharge. The sub-field of FIG. 10 can be allocated as a sub-field for a low gray-scale display. For example, by applying a ramp-type sustain pulse in a sustain time of a sub-field where a quantized integer portion [Ni] of equation 3 is zero, a sustain discharge can be performed.

To compensate for the sum of quantization errors in the sub-field having the quantized integer portion of zero, it is possible to apply a sub-field of FIG. 10 as a separate sub-field for compensation. A gradation is displayed by a sum of gradations allocated to respective sub-fields in a frame. Accordingly, to at once compensate for a sum of quantization errors of all sub-fields in a frame, it is possible to provide a separate sub-field for compensation, for example, as a final sub-field of the frame. This is expressed by equations 5 through 7.
Ni=[Ni]+αi (5)
αi=Ni−[Ni] (6)
Σαi=Σ(Ni−[Ni]) (7)

As shown in equation 7, the sum (Σαi) of the quantization errors in all sub-fields can be compensated for at once in a separate sub-field for compensation to which the ramp-type sustain pulse shown in FIG. 10 is supplied.

A panel driving method according to another embodiment of the present invention will be described with reference to equation 6, as follows.

The panel driving method quantizes the number of sustain pulses supplied to a sub-field, supplies a sustain pulse corresponding to a quantized integer portion using a square wave sustain pulse, and supplies a sustain pulse corresponding to a quantization error portion using a ramp-type sustain pulse, thereby performing a sustain discharge. Referring to equation 6, an integer portion [Ni] of a sustain pulse Ni is sustain-discharged by a square wave sustain pulse and an error portion α is sustain-discharged by a ramp-type sustain pulse.

The panel driving method of the present invention can be embodied as a program stored on a computer readable medium that can be run on a general purpose computer. The computer readable medium includes but is not limited to storage media such as magnetic storage media (e.g., ROM's, floppy disks, hard disks, etc.), optically readable media (e.g., CD-ROMs, DVDs, etc.), and carrier waves (e.g., transmission over the Internet). The present invention can also be embodied as a computer readable program code unit stored on a computer readable medium, for causing a number of computer systems connected via a network to affect distributed processing.

In particular, the method of driving a display panel according to the present invention can be made by a schematic or Very High Density Logic (VHDL) on a computer and implemented by a programmable integrated circuit, for example, a Field Programmable Gate Array (FPGA). The recording medium includes such a programmable integrated circuit.

As described above, according to the method of driving a display panel of the present invention, it is possible to prevent low gray-scale display deterioration due to sustain pulse quantization by performing a sustain discharge using a ramp-type sustain pulse.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

1. A method of driving a display panel comprising:
quantizing a sustain pulse; and
performing a sustain discharge by supplying a ramp-type sustain pulse in at least one sub-field.

2. The method of claim 1, wherein performing a sustain discharge comprises supplying the ramp-type sustain pulse in a sustain period of at least one sub-field upon the sustain period in which an integer portion obtained via quantization of the sustain pulse is equal to zero.

3. The method of claim 1, wherein performing a sustain discharge comprises supplying the ramp-type sustain pulse in at least one sub-field in accordance with a sum of quantization errors of a sub-field in which an integer portion obtained via quantization of a sustain pulse is equal to zero.

4. The method of claim 1, further comprising changing a ramp-wave maximum voltage of the ramp-type sustain pulse.

5. The method of claim 1, further comprising changing a ramp-wave rising period of the ramp-type sustain pulse.

6. A method of driving a display panel comprising:
quantizing the number of sustain pulses of a sustain discharge supplied to a sub-field;
supplying a quantized integer portion of each sustain pulse of a sustain discharge as a square wave sustain pulse; and
supplying a quantization error portion of each sustain pulse of a sustain discharge as a ramp-type sustain pulse.

7. The method of claim 6, further comprising changing a ramp-wave maximum voltage of the ramp-type sustain pulse.

8. The method of claim 6, further comprising changing a ramp-wave rising period of the ramp-type sustain pulse.

9. A program storage device, readable by a machine, tangibly embodying a program instructions executable by the machine to perform a method of driving a display panel, the method comprising:
quantizing a sustain pulse; and
performing a sustain discharge by supplying a ramp-type sustain pulse in at least one sub-field.

10. The program storage device of claim 9, wherein performing a sustain discharge comprises supplying the ramp-type sustain pulse in a sustain period of at least one sub-field upon the sustain period in which an integer portion obtained via quantization of the sustain pulse is equal to zero.

11. The program storage device of claim 9, wherein performing a sustain discharge comprises supplying the ramp-type sustain pulse in at least one sub-field in accordance with a sum of quantization errors of a sub-field in which an integer portion obtained via quantization of a sustain pulse is equal to zero.

12. The program storage device of claim 9, further comprising changing a ramp-wave maximum voltage of the ramp-type sustain pulse.

13. The program storage device of claim 9, further comprising changing a ramp-wave rising period of the ramp-type sustain pulse.

14. A program storage device, readable by a machine, tangibly embodying a program instructions executable by the machine to perform a method of driving a display panel, the method comprising:
quantizing the number of sustain pulses of a sustain discharge supplied to a sub-field;
supplying a quantized integer portion of each sustain pulse of a sustain discharge as a square wave sustain pulse; and
supplying a quantization error portion of each sustain pulse of a sustain discharge as a ramp-type sustain pulse.

15. The program storage device of claim 14, further comprising changing a ramp-wave maximum voltage of the ramp-type sustain pulse.

16. The program storage device of claim 14, further comprising changing a ramp-wave rising period of the ramp-type sustain pulse.
